(19) United States
(12) Patent Application Publication
(10) Pub. No.: US 2026/0067412 A1
(43) Pub. Date: Mar. 5, 2026

(54) INFORMATION PROCESSING APPARATUS, COLOR INSPECTION SYSTEM AND METHOD OF CONTROLLING THE SAME, AND STORAGE MEDIUM

(71) Applicant: CANON KABUSHIKI KAISHA, Tokyo (JP)

(72) Inventor: MAYATO SAKAGUCHI, Kanagawa (JP)

(21) Appl. No.: 19/301,776

(22) Filed: Aug. 15, 2025

(30) Foreign Application Priority Data
Aug. 29, 2024 (JP) 2024-147844

(51) Int. Cl. H04N 1/60; B41J 29/393

(52) U.S. Cl. CPC H04N 1/6036; B41J 29/393; B41J 2029/3935; H04N 2201/0094

(57) ABSTRACT

An information processing apparatus that, based on colorimetric data of patches arranged on charts printed by one or more printers, performs a color inspection of the printers. The information processing apparatus generates one color inspection job including chart data for performing color inspection of a plurality of printers, and performs control to display a color inspection result based on the one color inspection job. When displaying of the color inspection result, the information processing apparatus displays a color inspection result for the one color inspection job and a color inspection result for each of the plurality of printers.

### BACKGROUND

### Field of the Technology

The present disclosure relates to an information processing apparatus, a color inspection system, a method of controlling the same, and a storage medium.

### Description of the Related Art

There is a method of performing double-sided printing, with a commercial printer, at high speed by printing each of the front surface and the back surface using a plurality of printers that are connected. As color management when a plurality of printers are used in this manner, it is inspected whether or not colors printed by the respective printers satisfy pass criteria of respective target colors defined by a standard of the ISO or the like. When double-sided printing is performed using a plurality of printers connected in this manner, it is desirable that each printer satisfies the pass criteria in color inspection, but since it is necessary to perform color inspection for each of the printers, the color inspection operation takes a lot of effort. Japanese Patent Laid-Open No. 2023-122718 describes a technique in which a plurality of color inspection jobs corresponding to a plurality of printers are generated in one go when performing color inspection of the plurality of printers, and then each of the plurality of printers executes a corresponding color inspection job to print a colorimetric chart, and by collectively measuring the plurality of charts, the number of colorimetric operations is reduced, thereby improving the convenience of the user. The colorimetric chart may be hereinafter referred to “chart”.

Even in a case where color inspection is performed by a plurality of printers that are connected and that perform double-sided printing, it is possible to reduce the time and effort of the work by generating a plurality of color inspection jobs corresponding to the plurality of printers and collectively performing the color inspection on charts printed by the respective printers that execute the color inspection jobs. However, in the case where color inspection is performed by the above-described plurality of printers that are connected, the respective printers need to perform double-sided printing of charts for color inspection. In general, it is preferable that the back surface of a chart be made to be blank, but there is a problem in that the operation to perform such a print setting is complicated.

### SUMMARY

Embodiments of the present disclosure eliminate the above-mentioned issues with conventional technology.

A feature of embodiments of the present disclosure is to provide an improvement in the efficiency of a color inspection operation by generating charts that are printed by all printers in one color inspection job for a plurality of printers.

According to embodiments of the present disclosure, there is provided an information processing apparatus that, based on colorimetric data of patches arranged on charts printed by one or more printers, performs a color inspection of the printers, the information processing apparatus comprising: one or more controllers including one or more processors and one or more memories, the one or more controllers configured to: generate one color inspection job including chart data for performing color inspection of a plurality of printers; and perform control to display a color inspection result based on the one color inspection job, wherein, in the display of the color inspection result, the one or more controllers display a color inspection result for the one color inspection job and a color inspection result for each of the plurality of printers.

According to embodiments of the present disclosure, there is provided a color inspection system comprising an information processing apparatus that, based on colorimetric data of patches arranged on charts printed by one or more printers, performs a color inspection of the printers, and a measurement device, the information processing comprising: one or more controllers including one or more processors and one or more memories, the one or more controllers configured to: generate one color inspection job including chart data for performing color inspection of a plurality of printers; and perform control to display a color inspection result based on the one color inspection job, wherein, in the display of the color inspection result, the one or more controllers display a color inspection result for the one color inspection job and a color inspection result for each of the plurality of printers, and wherein the measurement device generates the colorimetric data by measuring patches on the charts printed by the plurality of printers, respectively. According to embodiments of the present disclosure, there is provided a method of controlling an information processing apparatus that, based on colorimetric data of patches arranged on charts printed by one or more printers, performs a color inspection of the printers, the method comprising: generating one color inspection job including chart data for performing color inspection of a plurality of printers; and performing control to display a color inspection result based on the one color inspection job, wherein, in the display of the color inspection result, a color inspection result for the one color inspection job and a color inspection result for each of the plurality of printers are displayed.

Further features of the various embodiments will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a conceptual diagram for describing an overall configuration of a color inspection system according to a first embodiment.

FIG. 2 is a diagram illustrating an example of a chart according to the first embodiment.

FIG. 3 is a block diagram for describing a hardware configuration of a color management apparatus and a control apparatus according to the first embodiment.

FIG. 4 is a block diagram for describing a main functional configuration of the color management apparatus and the control apparatus according to the first embodiment.

FIG. 5A depicts a view illustrating an example of an operation screen displayed on a display unit by the color management apparatus according to the first embodiment.

FIG. 5B depicts a view illustrating an example of an operation screen displayed on a display unit by the color management apparatus according to the first embodiment.

FIG. 5C depicts a view illustrating an example of an operation screen displayed on a display unit by the color management apparatus according to the first embodiment.

FIG. 5D depicts a view illustrating an example of an operation screen displayed on a display unit by the color management apparatus according to the first embodiment.

FIG. 5E depicts a view illustrating an example of an operation screen displayed on a display unit by the color management apparatus according to the first embodiment.

FIG. 5F depicts a view illustrating an example of an operation screen displayed on a display unit by the color management apparatus according to the first embodiment.

FIGS. 6A to 6E are diagrams for explaining an overview of a color inspection job specification setting function screen according to the first embodiment.

FIG. 7 is a sequence diagram illustrating a flow of processing in the color inspection system according to the first embodiment.

FIGS. 8A to 8C are diagrams illustrating examples of a color inspection chart according to the first embodiment.

FIG. 9 is a flowchart for explaining processing when a color inspection job generation module generates chart data in the color inspection system according to the first embodiment.

FIG. 10 is a flowchart for explaining processing when the color inspection job generation module generates chart data in the color inspection system according to a modification example of the first embodiment.

FIG. 11A is a diagram illustrating an example of a colorimetric condition according to a standard certification type, according to the first embodiment.

FIG. 11B is a diagram illustrating an example of allowable values according to the standard certification type.

FIG. 12 depicts a view illustrating an example of a color inspection job specification setting screen according to a second embodiment.

FIG. 13 is a flowchart for explaining processing when the color inspection job generation module generates chart data in the color inspection system according to the second embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

### First Embodiment

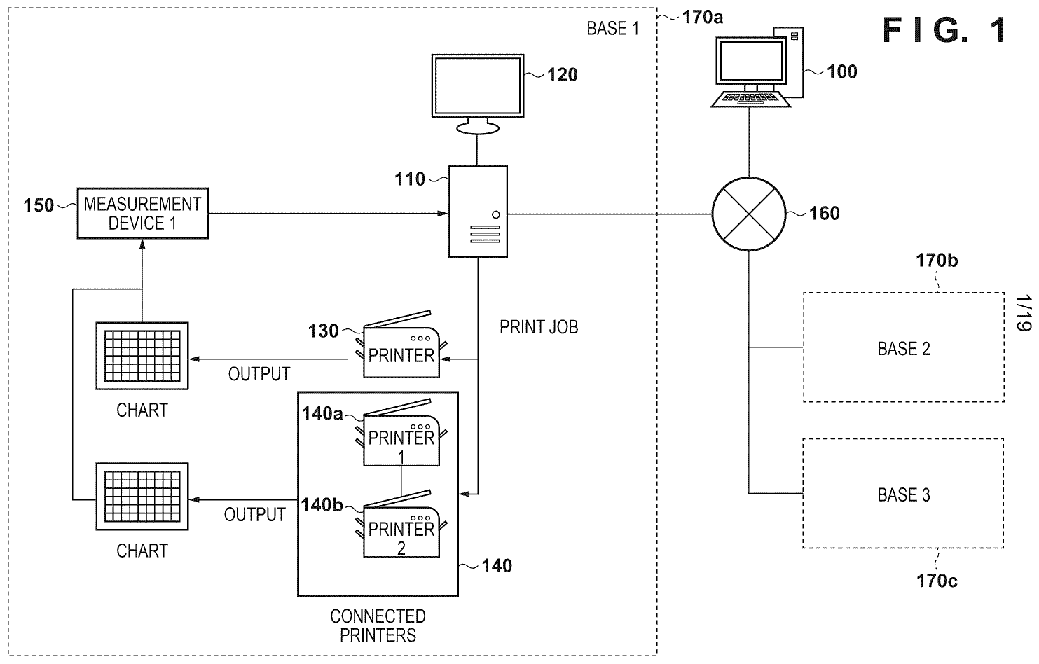

FIG. 1 is a conceptual diagram for describing an overall configuration of a color inspection system according to a first embodiment.

In this color inspection system, color inspection of each printer is periodically performed in order to comprehensively manage colors of the printers. In the color inspection, first, a predetermined chart is printed by a target printer and outputted. Next, color patches on the printed chart are measured, and deviation (color accuracy) between the obtained printed color measurement data and the reference color is checked. Note that the color patches arranged in this chart are also referred to as color swatches or color samples, and are simply referred to as “patches” in this specification.

In the color inspection system described in FIG. 1, a color management apparatus 100 and bases 170a to 170c are connected via a network 160. The base 170a includes a control apparatus 110, a monitor 120, a printer 130, connected printers 140, and a measurement device 150. Also, although not illustrated, the base 170b and the base 170c each include a control apparatus, a monitor, printers, and a measurement device, similarly to the base 170a. Hereinafter, the relationship between the base 170a (base 1) and the color management apparatus 100 will be described as an example, and since the bases 170b (base 2) and 170c (base 3) have the same configuration, description thereof will be omitted.

The color management apparatus 100 is connected to the control apparatus 110 such that they are enabled to communicate with each other via the network 160. The color management apparatus 100 has a function of setting specifications of a color inspection job, and issues a color inspection job in accordance with the set color inspection job specifications. The color management apparatus 100 generates color inspection chart data (hereinafter, chart data) to which an ID (identification information) associated with the color inspection job is added, and provides the generated chart data to the control apparatus 110. Then, a target printer corresponding to the printer information set in the color inspection job specification prints a chart based on the chart data via the control apparatus 110. Further, the color management apparatus 100 compares a color that is a preset reference (reference color) with a measured value of a color (printed color) of a chart actually printed by the printer, which is obtained via the control apparatus 110, and inspects whether or not the color accuracy satisfies pass criteria. Further, the color management apparatus 100 performs comprehensive management of the color inspection results of each of the printers connected via the control apparatus 110.

The control apparatus 110 is connected to the printer 130 and the connected printers 140 in the base 170a via a communication network such as an intranet so that they are able to communicate with each other, and obtains device information of the printers and gives an instruction to print to the printers. Device information of a printer includes available sheet information and print condition information such as available print profiles. Also, a print instruction to a printer includes an instruction to print chart data received from the color management apparatus 100.

The control apparatus 110 is connected to the measurement device 150 via a USB cable or a communication network such as an intranet so that they are able to communicate with each other, and, in addition to controlling the measurement device 150, the control apparatus 110 also transmits obtained measurement data to the color management apparatus 100.

The monitor 120 is connected to the control apparatus 110 and displays various user interface screens (UI screens).

The printer 130 prints a color image on a sheet based on a print job from the control apparatus 110 using, for example, an electrophotographic process technology. The printer 130 may be a monochrome printer or a printer based on another image forming technique such as an inkjet printer. In addition, the printer 130 may be a multifunction peripheral having a copying function and a FAX function in addition to the printing function.

The connected printers 140 are a printer having a plurality of printing mechanisms such as printers 1 to 2 (140a and 140b), and print monochrome or color images on sheets by using the printers 140a to 140b based on a print job from the control apparatus 110. The printers 140a and 140b may each be usable independently as a single printer, as with the printer 130, or may be devices having only a mechanism for printing. When double-sided printing is performed by the connected printers 140, the printers 140a and 140b print respectively different surfaces, and when single-sided printing is performed, printing is performed by either one of the printers 140a and 140b or distributed printing is performed by both of the printers 140a and 140b. Here, the connected printers 140 perform printing on, for example, roll paper, and the printer 140a and the printer 140b are hardware mechanisms capable of performing only single-sided printing. When double-sided printing is performed, for example, the printer 140a prints the front surface, and the printer 140b prints the back surface, thereby realizing double-sided printing. In the following explanation, the printers 140a and 140b of the connected printers 140 may be denoted as the printer 1 and the printer 2, respectively.

The measurement device 150 is a spectrophotometer that measures color values of an object based on the reflectance or transmittance of visible light having a wavelength of 400 nm to 700 nm. The measurement device 150 is prepared for each base, for example, and measures charts printed out from the printer 130 and the connected printers 140, and converts the wavelengths obtained for each patch on the charts into values in the L*a*b* color space and XYZ color space, for example, to obtain measurement data.

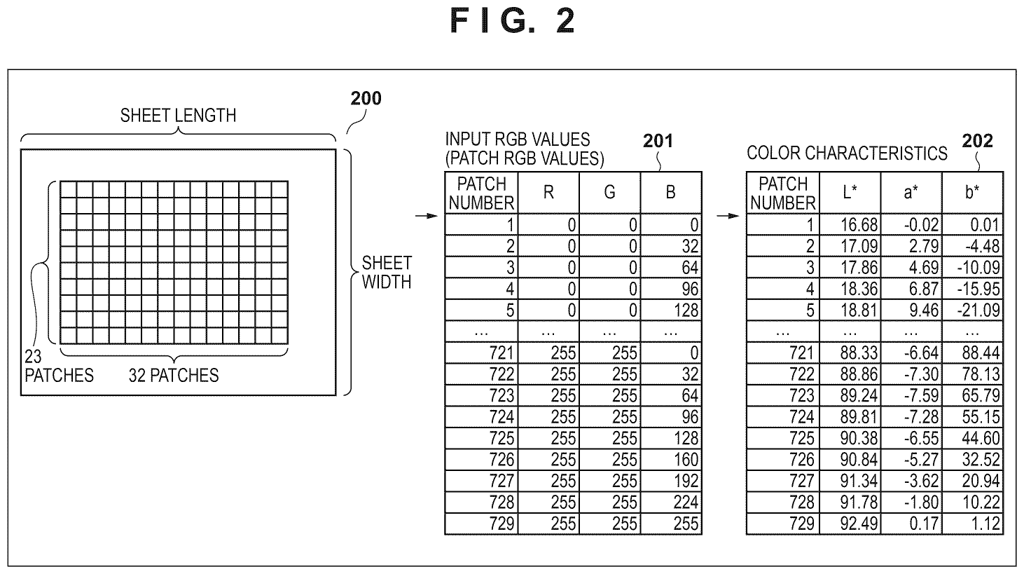

FIG. 2 is a diagram illustrating an example of a chart according to the first embodiment.

A chart 200 illustrates an example of a chart. Reference numeral 201 denotes signal values (RGB values) defined in an RGB color space corresponding to the respective patches (patch numbers 1 to 729) of the chart 200. Also, reference numeral 202 denotes an example of measurement data for which color values of respective patches on the chart which have been printed by a printer have been obtained by a measurement device. Note that the values denoted by the reference numeral 201 are not limited to signal values in RGB color space, and may be signal values (CMYK values) defined in CMYK color space. The measurement device 150 is, for example, a measurement device incorporating a line sensor or an area sensor for scanning a chart. In the case of a sheet-through type automatic document reading measurement device, because a line sensor or an area sensor is built in, it is possible perform measurement after having pre-scanned a chart and detected the positions of patches to be measured. In sheet-through type measurement devices, in addition to manual sheet feeding in which charts are manually fed one by one, there are also measurement devices in which a plurality of charts are stacked and measurement is started by using an automatic sheet feeding unit, so that consecutive page measurement can be performed by automatically feeding sheets one by one. The measurement device 150 is not limited to a sheet-through type measurement device or the like, and may be, for example, a portable (handheld) measurement device for performing measurement by manually moving the measurement device over patches of a chart.

The network 160 may be, for example, a local area network (LAN), the Internet, an intranet, or the like, and may be wired or wireless.

The bases 170a to 170c correspond to locations of a printing company where printers are installed, or the like. For example, the base 170a is a printing base in Tokyo, the base 170b is a printing base in Osaka, and the base 170c is a printing base in Fukuoka.

Note that the configuration of the color inspection system illustrated in FIG. 1 is only one example, and the number of bases and the configuration of apparatuses in each base can be changed as appropriate. For example, in a case where the color management apparatus 100 is installed at each of the bases 170a to 170c, the color management apparatus 100 is directly connected to printers and measurement devices. The color management apparatus 100 may be configured to instruct a printer to print a chart and obtain measurement data from the measurement device without going through the control apparatus 110. Further, an information processing apparatus having the functions of both the color management apparatus 100 and the control apparatus 110 may be provided at each base, and the information processing apparatus may be configured to perform color management of a plurality of printers in the base. That is, an information processing apparatus having the functions of both the color management apparatus 100 and the control apparatus 110 may be provided for each base, and the information processing apparatus may be configured to perform color management of a plurality of printers in the base.

Each of the color management apparatus 100 and the control apparatus 110 described above is an information processing apparatus, and is realized by, for example, a general-purpose notebook or desktop personal computer, a server terminal, or a tablet terminal.

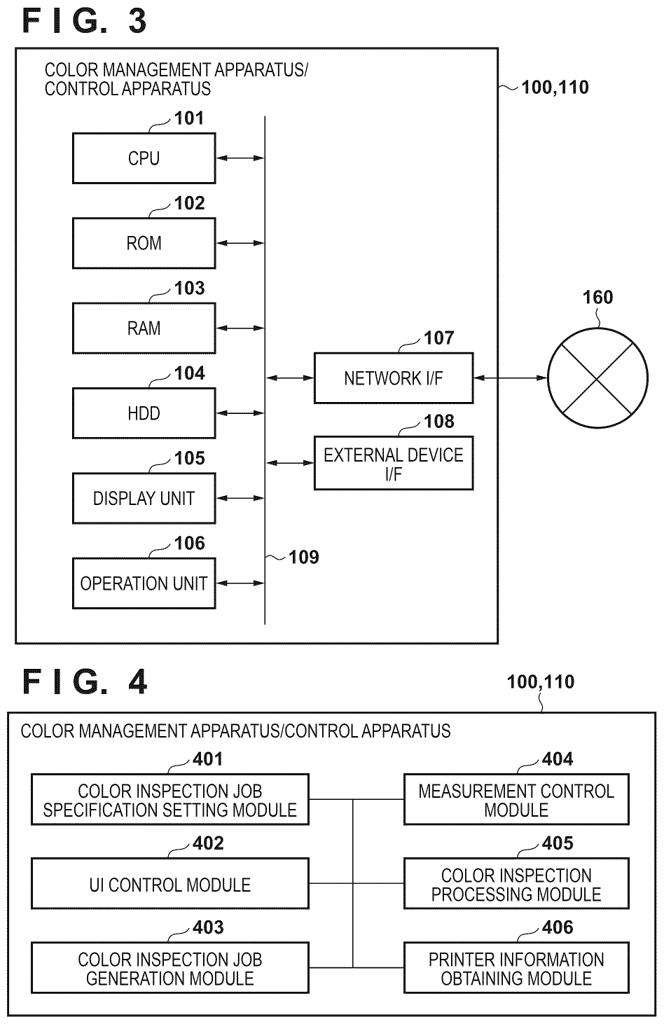

FIG. 3 is a block diagram for describing a hardware configuration of the color management apparatus 100 and the control apparatus 110 according to the first embodiment. The hardware configuration of the color management apparatus 100 is described here, but the same applies to the control apparatus 110.

The color management apparatus 100 includes a CPU 101, a ROM 102, a RAM 103, a hard desk drive (HDD) 104, a display unit 105, an operation unit 106, a network interface (I/F) 107, and an external device I/F 108. The respective units denoted by reference numerals 101 to 108 illustrated in FIG. 3 are connected to each other via a system bus 109.

The CPU 101 is an arithmetic processing apparatus that controls the entire color management apparatus 100, and executes each of the image processes described later based on a program stored in the ROM 102. The ROM 102 is a read-only memory and stores a boot program, a processing program, character data, character code information, and the like. The RAM 103 is a random access memory and is used as a deployment area and a work memory of a program when the CPU 101 executes various programs. Also, the RAM 103 is used as a storage for image files received via the network I/F 107, or the like. The HDD 104 is used to store the results of arithmetic processing executed by the CPU 101, various programs, information files, and the like. The display unit 105 is constituted by, for example, a liquid crystal display or the like, and displays a user interface screen for inputting various settings and confirming a status of an apparatus. The operation unit 106 includes a keyboard, a pointing device, and the like, and is used by a user to input and reset various setting values, and the like. The network I/F 107 is an interface for connecting the color management apparatus 100 to the network 160. The color management apparatus 100 can transmit and receive various types of information to and from an external apparatus via the network I/F 107. The external device I/F 108 is an interface for connecting external devices such as the measurement device 150 via a communication bus such as a Universal Serial Bus (USB), for example.

Next, a configuration of software of the color management apparatus 100 and the control apparatus 110 will be described.

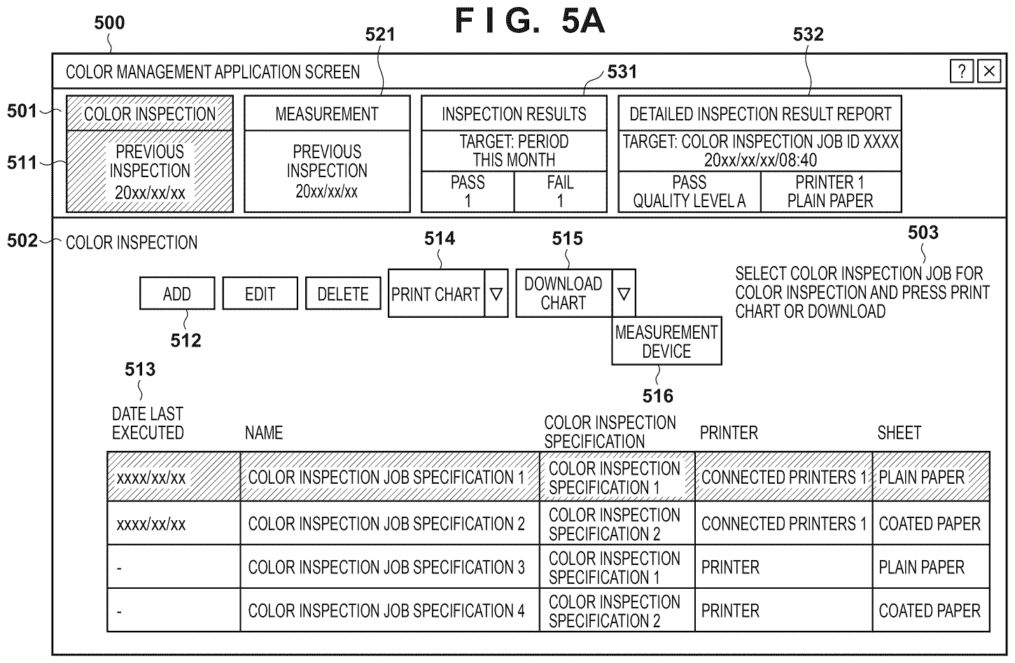

FIG. 4 is a block diagram for describing a main functional configuration of the color management apparatus 100 and the control apparatus 110 according to the first embodiment. The software configuration of the color management apparatus 100 is described below, but the same applies to the control apparatus 110. However, in the case of the control apparatus 110, the control apparatus 110 directly obtains device information of the printer, print instructions to the printer, and the like.

The color management apparatus 100 includes a color inspection job specification setting module 401, a UI control module 402, a color inspection job generation module 403, a measurement control module 404, a color inspection processing module 405, and a printer information obtaining module 406. Each of these functional units is realized by the CPU 101 deploying a predetermined program stored in the ROM 102 into the RAM 103 and executing the program. Hereinafter, each functional unit will be described.

The color inspection job specification setting module 401 sets specifications of the color inspection job. Specifically, in addition to the printer to be the target of the color inspection and the sheet conditions of a sheet on which a chart is to be printed, settings of a measurement device to be used for measurement of the chart, color inspection specifications, and the like are made. Since color reproduction accuracy of the printer greatly varies depending on the combination of the printer and the sheet, it is necessary to perform color inspection and color management for each set of printer and sheet condition. Therefore, the color inspection job specification setting module 401 specifics a printer for performing color inspection from among the printers connected to the control apparatus 110. In addition, a sheet to be used for color inspection is set from among predefined sheets or sheets included in the device information of the printer received via the control apparatus 110. In addition, design specifications of a chart, such as a measurable patch size, patch arrangement considering a margin, and specifications of markers for ascertaining patch arrangement, are defined in accordance with the measurement device. Therefore, in order to generate measurable chart data and print it with a printer, it is necessary to designate a measurement device to be used. Thus, the color inspection job specification setting module 401 sets a predefined type of measurement device or the measurement device 150, which has been connected to the control apparatus 110, as a measurement device to be used for color inspection. Further, the color inspection job specification setting module 401 sets details of color inspection specifications (chart specifications (such as the number of patches and patch signal values), a reference value set, an allowable value set, an evaluation mode, measurement conditions, print conditions, and the like) necessary for the color inspection processing.

Chart specifications at the time of performing color inspection are roughly classified into default charts according to a standard of the International Standard Organization (ISO) or the like and custom charts defined independently by a user. A predetermined chart is registered in advance prior to the start of use, for example, at the time of installation of a color management program or the like. For a custom chart, inputting of the custom chart information from the operation unit 106 is accepted, and the color inspection job specification setting module 401 performs settings at an arbitrary timing.

In addition, the reference value set, the allowable value set, the evaluation mode, the measurement conditions, and the print conditions at the time of performing the color inspection are set to conditions defined by Japan Color certification which complies with the ISO, or the like. Allowable values are values used when color accuracy is obtained by comparing a predetermined reference color (reference color) with a measured value of a color actually printed by the printer (printed color), and it is determined whether the color accuracy satisfies the pass criteria. For example, when determining whether or not the color accuracy satisfies the pass criteria based on the difference (color difference) between the color value (reference value) of the reference color and the color value (measured value) of a printed color, it is determined that the color accuracy satisfies the pass criteria if an allowable color difference value is registered as the allowable value and the difference is within the allowable value. When performing color inspection, upon receiving an instruction to select the specifications of a color inspection job set by the color inspection job specification setting module 401 and start the inspection, the color inspection job generation module 403, which will be described later, generates a color inspection job, thereby starting the color inspection.

The UI control module 402 controls the display of user interface screens for state confirmation for each apparatus in the color inspection system; input and selection of various setting values; and acceptance of instructions to start various processes or the like. The displayed user interface screen will be described later.

The color inspection job generation module 403 selects the specifications of a color inspection job set by the color inspection job specification setting module 401, and upon accepting an instruction to start an inspection, generates a color inspection job based on the specifications. Then, the color inspection job generation module 403 issues a color inspection job ID for each generated color inspection job.

Further, the color inspection job generation module 403 generates chart data based on a measurement device corresponding to the specifications of the selected color inspection job and the chart specifications and the like, and transmits the chart data to the control apparatus 110. At this time, a color inspection job ID is added to the chart data. In the first embodiment, the color inspection job ID has two types of IDs: a four-digit ID that is repeatedly used in a short period for visual confirmation by a person and a 32-digit ID for system management by the color management apparatus 100, but the present disclosure is not limited thereto. In addition, in the case where the printer that performs color inspection is a printer having a plurality of printing mechanisms such as the connected printers 140, a chart is created in consideration of imposition such that a chart is printed by all printing mechanisms. Details of a function for creating a chart related to features of the first embodiment will be described later. A chart is printed by a printer set in the color inspection job specifications via the control apparatus 110.

The measurement control module 404 performs colorimetry of the chart using the measurement device 150. Further, the measurement control module 404 transmits colorimetric data received from the measurement device 150 to the color inspection processing module 405. The color inspection processing module 405 uses the colorimetric data received from the measurement control module 404 to perform inspection processing for determining whether or not the color accuracy of the target printer in which the chart is printed meets the pass criteria. The printer information obtaining module 406 obtains printer setting values such as a double-sided setting and the sheet type. In the first embodiment, the printer information obtaining module 406 obtains information indicating which surface is to be printed by any one of the printers 140a and 140b when the connected printers 140 perform double-sided printing, but the present disclosure is not limited to this.

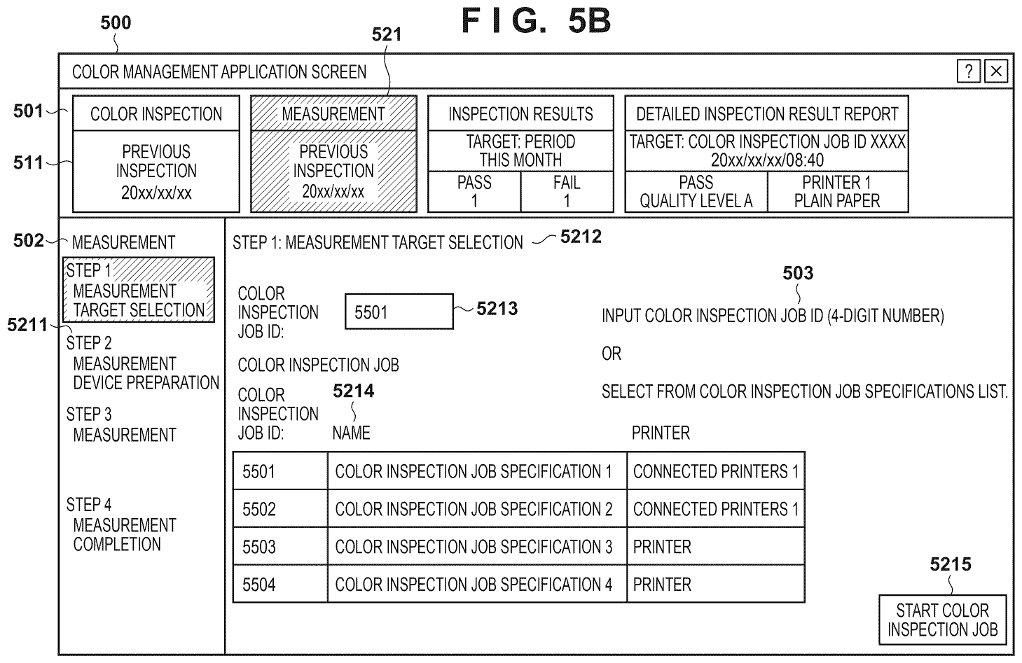

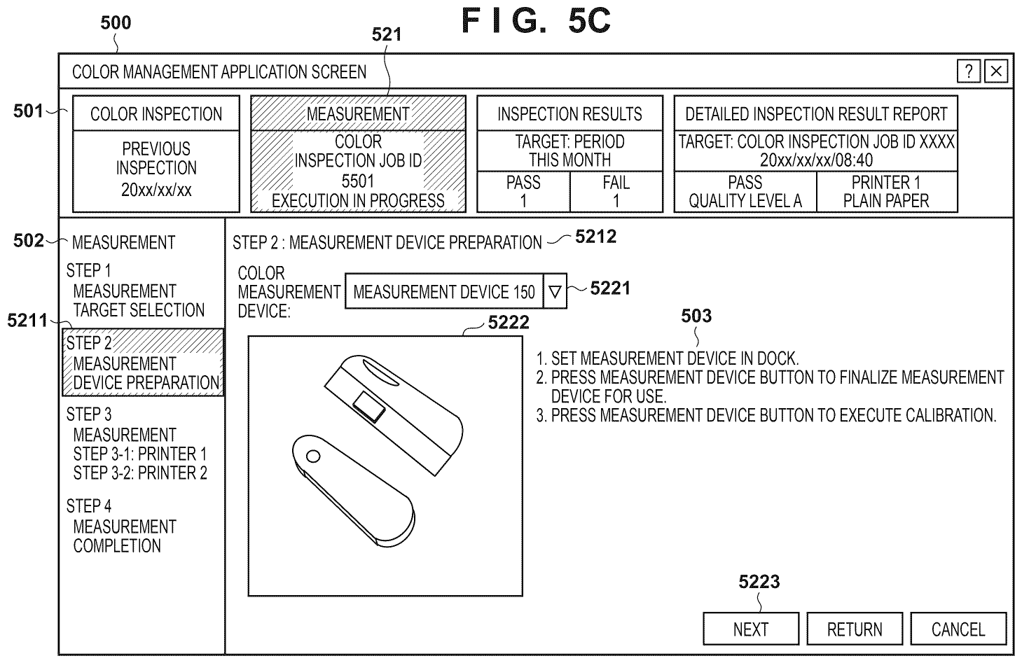

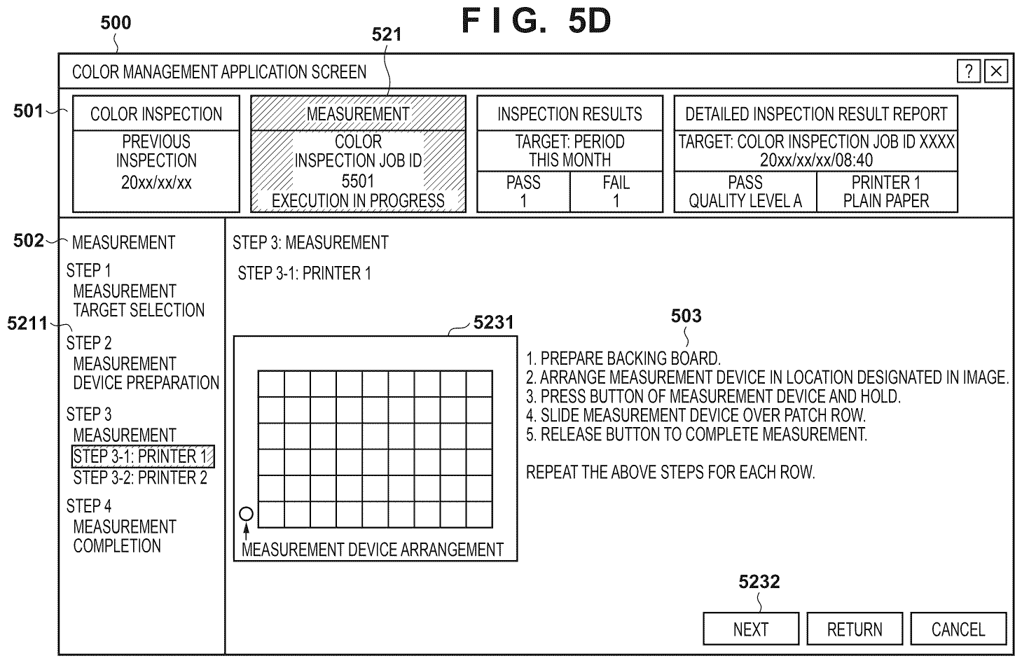

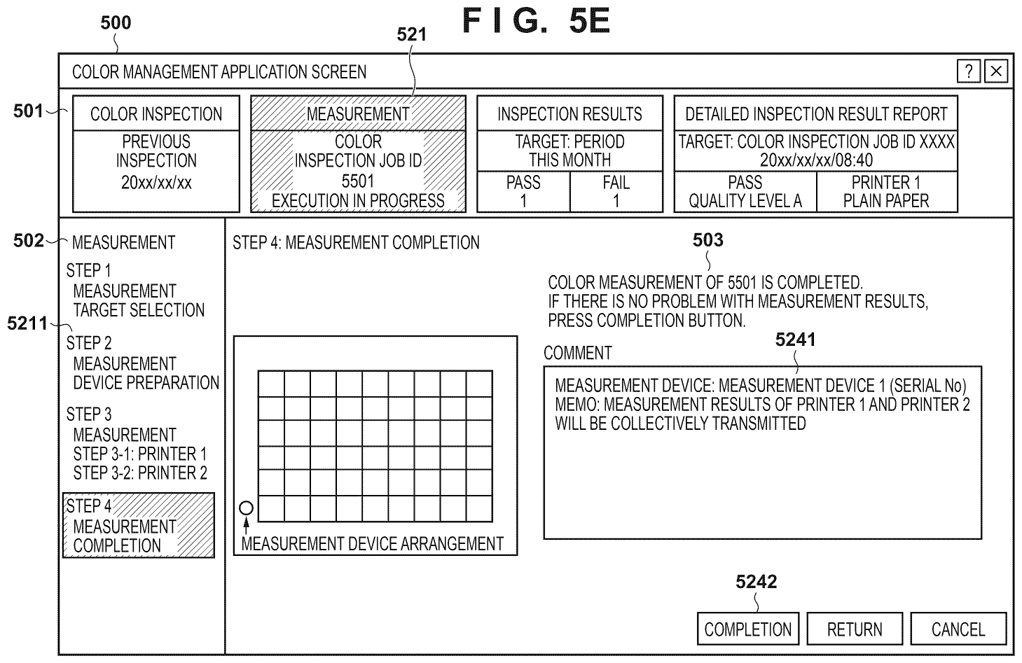

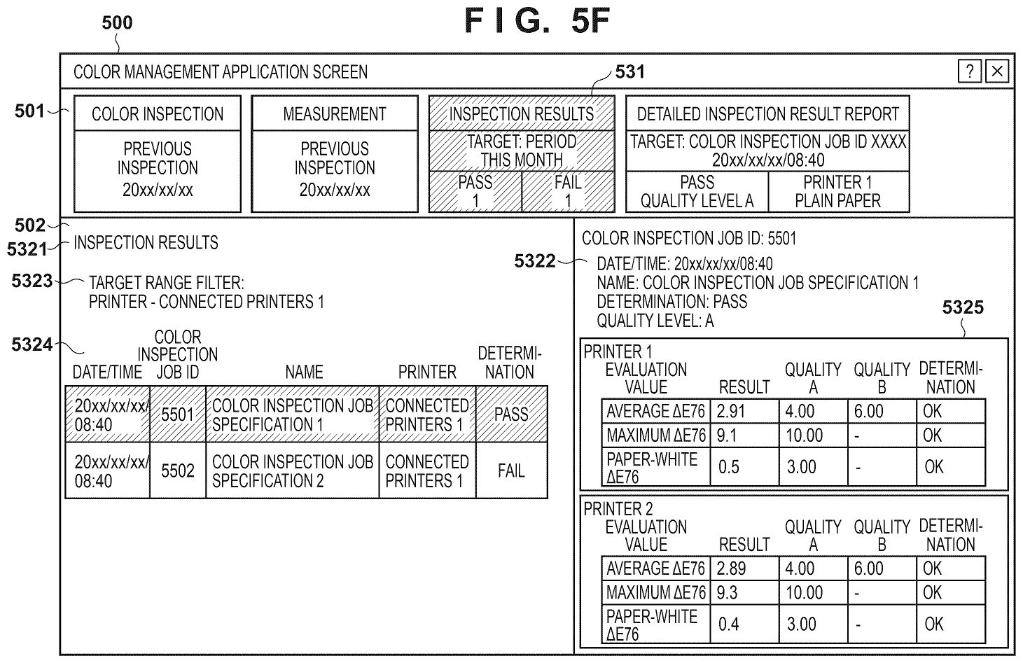

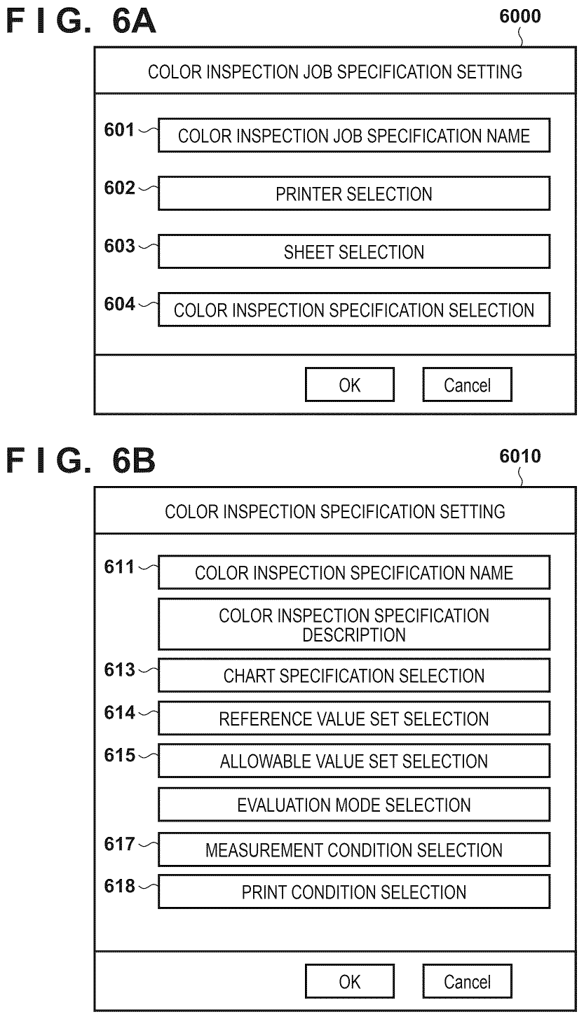

FIGS. 5A to 5F depict views respectively illustrating examples of an operation screen 500 displayed on the display unit 105 by the color management apparatus 100 according to the first embodiment.

The operation screen 500 has a function card display area 501 for displaying function cards used in color management, and a function display area 502 for displaying functions of a card that is currently selected in the function card display area 501.

First, an overview of functions that can be used with each function card displayed in the function card display area 501 will be described. A plurality of function cards for inspection results and detailed inspection result reports and the like can be activated and displayed if the contents of the card are based on different conditions.

With respect to a color inspection function card 511, the UI control module 402 has a function for setting color inspection job specifications and starting a color inspection job, and displays digest information such as date and time information of the previous execution of the color inspection job on the card.

With respect to a measurement function card 521, the UI control module 402 has functions for starting a color inspection job, preparing a measurement device, taking a measurement, transmitting a measurement result, and the like, and displays digest information such as date and time at which a color inspection job was last executed, on the color inspection function card 511.

In the first embodiment, with respect to the measurement function card 521, when the printer that performs color inspection is a printer having a plurality of printing mechanisms such as the connected printers 140, the measurement control module 404 collectively executes the color inspection job on a plurality of printers in one color inspection job. Then, the measurement results are notified.

With respect to an inspection result function card 531, the UI control module 402 has a function of displaying inspection results of a color inspection job, and displays digest information such as inspection results of each printer on the card.

With respect to a detailed inspection result report function card 532, the UI control module 402 has a function of displaying a detailed report of the inspection results of the color inspection job, and displays digest information such as the inspection results, a quality level, a target printer, and a sheet on the card.

Next, referring to FIG. 5A, an overview of the color inspection function screen displayed in the function display area 502 when the color inspection function card 511 is selected will be described. In an operation explanation area 503, how to operate the currently displayed function screen is displayed. Note that, in FIG. 5A, an operation explanation for the color inspection function screen is illustrated.

Buttons 512 for adding, deleting, and editing color inspection job specifications enable color inspection job specifications to be added to the color inspection job specifications list 513, deleted therefrom, and edited. Also, by pressing the region in the left portion of the “print chart” button 514 in a state where one color inspection job specifications item is selected in the color inspection job specifications list 513, the selected chart data for color inspection can be printed on a printer set in the specifications of the color inspection job.

Also, by pressing the region in the left portion of a “download chart” button 515, the chart data for the selected color inspection can be downloaded as an image file such as a PDF. Here, it is assumed that chart data corresponding to the measurement device 150 is generated. Further, by pressing the arrow in the region in the right portion of the “print chart” button 514 and the “download chart” button 515, a selection button 516 for selecting the measurement device for measuring the chart is displayed adjacent to the respective region. By pressing the measurement device selection button 516, chart data corresponding to the selected type of measurement device is generated, and printing or downloading is started. This makes it possible to select a measurement device from among the measurement devices connected to the control apparatus 110.

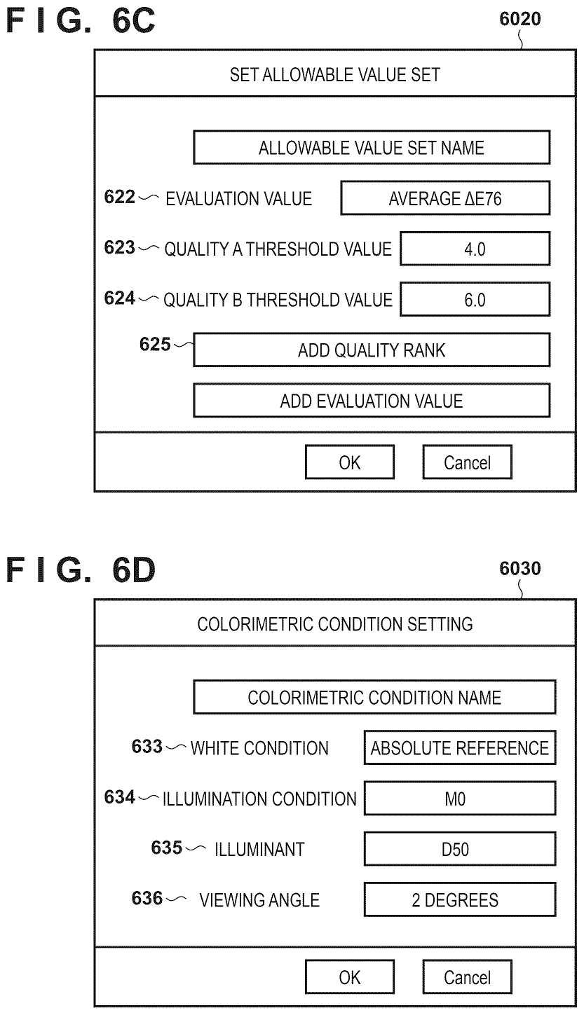

Next, referring to FIGS. 6A to 6E, an overview of a color inspection job specification setting function screen will be described.

The UI control module 402, after having accepted a pressing of the color inspection job specifications add/edit button 512 of FIG. 5A, transitions to a color inspection job specification setting screen 6000 illustrated in FIG. 6A.

In the color inspection job specification setting screen 6000, the UI control module 402 accepts a printer selection 602 and a sheet selection 603 with which color inspection is to be performed, as well as settings such as color inspection specifications indicating a color inspection method, measurement device information related to a chart print layout, and the like. Also, the color inspection job specification setting module 401 registers the color inspection job specifications with a name designated in a color inspection job specification name 601 for the various settings accepted from the UI control module 402. Note that with a color inspection specification selection 604, it is possible to add, delete, or edit color inspection specifications by using a menu (not shown), and the UI control module 402, after having accepted an instruction to add or edit color inspection specifications, transitions to a color inspection specification setting screen 6010 illustrated in FIG. 6B.

In the color inspection specification setting screen 6010, settings for chart specifications to be used for color inspection, reference values and allowable values corresponding to a chart, an evaluation mode in color inspection processing, chart measurement conditions, print conditions, and the like are accepted. The color inspection job specification setting module 401 registers the color inspection specification with a name designated in a color inspection specification name 611 for the various settings accepted from the UI control module 402. Note that the setting of each item of the color inspection specification can be added, deleted, or edited by using a menu (not shown), and the UI control module 402, after having accepted an instruction to add or edit, transitions to each detailed setting screen as illustrated in, for example, FIG. 6C to FIG. 6E, or the like.

In an allowable value setting screen 6020 illustrated in FIG. 6C, the UI control module 402 accepts settings for an evaluation value 622 and threshold values for quality ranks and pass/fail determination in the case where that evaluation value is used. A plurality of types of evaluation values and quality ranks can be set. For example, if the setting of the evaluation value 622 is the average ΔE76, the color inspection processing module 405 calculates a value obtained by averaging the linear distance (Expression (1)) between the reference color values (the values set in the reference value set selection 614) in the L*a*b* color space and the measured values obtained by measuring each patch of the chart. Also, a quality A threshold value 623 and a quality B threshold value 624 which correspond to quality ranks are compared, and if the value of the average ΔE76 is 4 or less, the quality rank A is set, and if the value is 6 or less, the quality rank B is set, and if the value is larger than the set threshold value 6, it is treated as a fail. Further quality ranks can be added by designating an addition of quality ranks 625. The method for determining a pass or a fail is not limited to this, and the UI control module 402 may separately set a quality rank for determining whether it is a pass on a not-shown setting UI. For example, the pass determination may be such that the quality rank A is set and thereby passing is determined only in the case where the threshold value of the quality rank A is satisfied.

$$Δ E = \sqrt{( Δ {L}^{2} + Δ {a}^{2} + Δ {b}^{2} )} \qquad Expression 1$$

$$Here , Δ L = {L}_{1} - {L}_{2} , Δ a = {a}_{1} - {a}_{2} , and Δ b = {b}_{1} - {b}_{2} .$$

In a colorimetric condition setting screen 6030 illustrated in FIG. 6D, the UI control module 402 accepts settings of a white condition 633, an illumination condition 634, an illuminant 635, a viewing angle 636, and the like, but is not limited thereto. The white condition 633 is selected because there is a “paper-white white reference” based on a white background of a printed paper and an “absolute white reference” based on a white reference plate (white tile) of a color measurement device. For the illumination condition 634, “M0”, “M1”, “M2”, and “M3” as standardized in ISO 13655 are indicated, and one of these is selected. For the illuminant (observation light source) 635, the type of light source data incorporated when calculating L*a*b* is selected. Examples of the type include “A”, “D50”, “D65”, and the like. The viewing angle 636 relates to a viewing angle (size of an object) when a person views an object, and is selected from “two-degree field of view”, “ten-degree field of view” as defined by the ISO, and the like.

In the print condition setting screen 6040 illustrated in FIG. 6E, the UI control module 402 accepts settings such as a CMYK input profile 642, a rendering indent 643, a black preservation 644, a black spot correction 645, and a double-sided setting 646, but limitation is not made thereto. In a case where an RGB image is set in a “chart specification selection” 613 in FIG. 6B, an RGB input profile setting may be accepted, or device information of a printer may be obtained and changed into a setting item in accordance therewith.

Since these color inspection specifications are settings of specifications for a target of color inspection, they are customized as appropriate according to the use case, and there is no limitation to those described above.

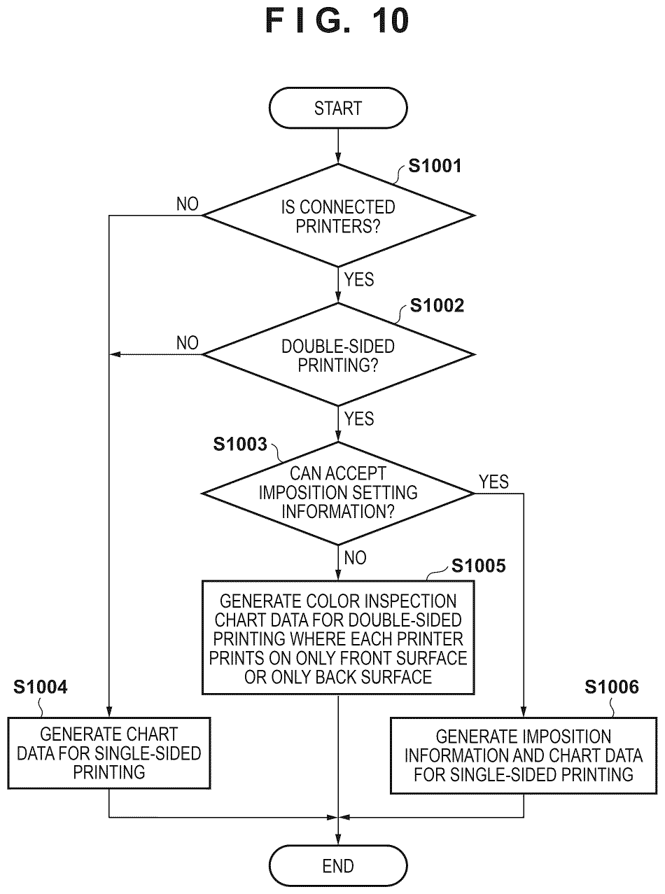

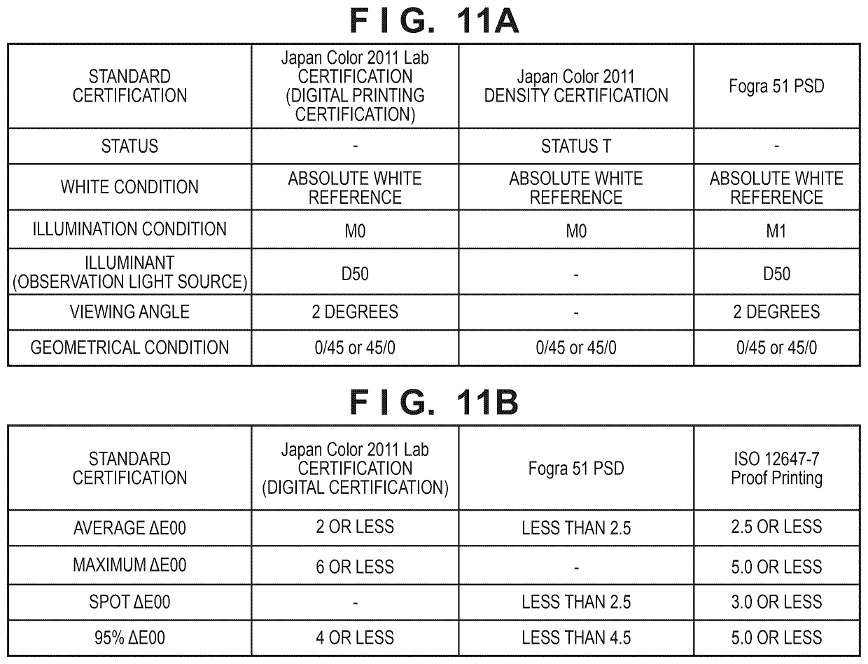

The color inspection specifications are determined in advance according to the type of standard certification in a case of performing color inspection in accordance with Japan Color certification and Fogra certification and the like, which conform to international ISO standards. For example, in the case of a “measurement condition selection” 617 in FIG. 6B, the colorimetric conditions are selected in accordance with the type of the standard certification as illustrated in FIG. 11A. Also, in the case of “allowable value set selection” 615 in FIG. 6A, allowable values are selected in accordance with the type of the standard certification as illustrated in FIG. 11B. In addition to this, a default is set to include a profile that uses a “print condition selection” 618 or the like. Therefore, it is assumed that the color inspection job specification setting module 401 holds, in advance, color inspection specification settings corresponding to a standard certification.

In a case where the printer selected by the printer selection 602 in FIG. 6A supports double-sided printing, the double-sided setting 646 of the print condition in FIG. 6E is displayed, and a double-sided setting for the time of chart printing can be selected. Meanwhile, when the printer selected by the printer selection 602 does not support double-sided printing, configuration is such that the double-sided setting 646 is not displayed or cannot be selected.

Next, referring to FIG. 5B, an overview of a measurement function screen displayed in the function display area 502 when the measurement function card 521 is selected will be described.

The function display area 502 in the measurement function includes a display area 5211 for displaying all work steps in the measurement function, and a current work step item area 5212 for displaying the current work step. In the current work step item area 5212, a color inspection job to be executed and a measurement target selection for selecting a printer to be used therefor are displayed. An overview of each of work steps 1 to 4 displayed in the display area 5211 for all work steps in the measurement function will be described later with reference to FIG. 5B to FIG. 5E. Note that the UI control module 402 highlights the display of the current work step in the display area 5211 of the work steps of the measurement function. FIG. 5B illustrates an example of an operation screen for a measurement target selection step where step 1, measurement target selection, is highlighted in the display.

In the measurement target selection step, the UI control module 402 accepts the designation of a color inspection job ID number added to the chart data in a text box 5213. Alternatively, the UI control module 402 accepts the selection of the color inspection job specification from a color inspection job specification list 5214 which is registered for the color inspection function card 511. In the operation explanation area 503, how to select the color inspection job specification is described. The UI control module 402 may accept the setting from either the text box 5213 or the color inspection job specification list 5214, and may restrict the displaying of operations so that both cannot be designated at the same time. In FIG. 5B, the color inspection job specification 1 in which the connected printers 140 are used of the color inspection job ID “5501” is selected. In the first embodiment, a job that is made to be measurement targets is not limited to the color inspection job, and may be a job that requires chart measurement, such as a profile generation job. When the UI control module 402 accepts the pressing of a color inspection job start button 5215, it transitions to a screen for the subsequent step 2.

FIG. 5C depicts a view illustrating an example of an operation screen for a measurement device preparation step, step 2, when the measurement function card 521 is selected. In the current work step item area 5212 of FIG. 5C, it is displayed that a measurement device to be used for the color inspection job is to be prepared. In the measurement device preparation step, the UI control module 402 displays the color inspection job ID (here, 5501) of the job that is currently being executed on the measurement function card 521. Further, based on the measurement device information included in the specification setting of the color inspection job that is the measurement target, a name 5221 and an illustration 5222 of the measurement device, from among the measurement devices connected to the control apparatus 110, that is to be used for measurement of the chart are displayed. When a plurality of measurement devices of the same type are connected, the names of the measurement devices are displayed in a list in the measurement device name 5221. Also, in the operation explanation area 503, operations for preparing a measurement device are described.

The measurement control module 404, upon accepting the designation of the measurement device from the UI control module 402 by the measurement device name 5221, issues a request to connect to the target measurement device and executes calibration of the measurement device. In this way, parts pertaining to the measurement device are prepared. Note that the step of preparing the measurement device described here is only one example, and this preparation step is assumed to vary depending on the measurement device specifications. The UI control module 402, when a next button 5223 is pressed, transitions to a screen for subsequent step 3.

FIG. 5D depicts a view illustrating an example of an operation screen for a measurement step, step 3, when the measurement function card 521 is selected.

The UI control module 402, in a case of performing measurement after printing a chart using a plurality of printers as in the case where the measurement target printer is connected printers, generates measurement steps, such as step 3-1 and step 3-2 for the respective printers, as illustrated in the display area 5211 for all work steps in the measurement function. In a case where there is only one printer that is the measurement target, the above-described steps are not provided. The UI control module 402 displays a measurement target chart 5231 to be used in the color inspection job. Then, the measurement control module 404 communicates with the measurement device designated in step 2, and measures patches using the measurement device. Note that the measurement method is only one example, and it is assumed that the measurement method will change depending on the specifications of the measurement device. When a next button 5232 is pressed after completion of the measurement, the UI control module 402 transitions to a screen for the subsequent step. In a case where the measurement target printer includes a plurality of printers, as in the case of connected printers, step 3-2 is transitioned to from step 3-1. Then, step 3-2 is executed, or, in a case where there is only one measurement target printer, step 4 is transitioned to. In step 3-2, similarly to step 3-1, a chart printed and outputted by a second printer (for example, a printer 140b) is measured. In the operation explanation area 503 of FIG. 5D, operations for measuring the chart using a measurement device are described.

Next, referring to FIG. 5E, a measurement completion step, step 4, will be described.

The UI control module 402 displays a description that the color measurement for which the color inspection job ID is “5501” is completed in the operation explanation area 503 of FIG. 5E. Furthermore, the UI control module 402 displays a comment field 5241 corresponding to the color inspection job. This field explains that since the color inspection job has been executed using the connected printers 140, the measurement results of a chart printed by the printer 1 and the printer 2 of the connected printers 140 are to be transmitted collectively. Then, the UI control module 402 ends the color inspection job when it accepts the pressing of a completion button 5242. Upon accepting the pressing of the completion button 5242, the measurement control module 404 collectively transmits to the color inspection processing module 405 the information to be displayed in the comment field 5241, the patch measurement result, and the like for the color inspection job.

Next, referring to FIG. 5F, an example of an operation screen for displaying inspection results when the inspection result function card 531 is selected is illustrated. Here, inspection results corresponding to the color inspection job are displayed in the function display area 502.

The function display area 502 for the inspection result confirmation function includes an inspection result 5321, a color inspection result list 5324, and an inspection result overview display area 5322 for the color inspection job ID selected in the color inspection result list 5324. In response to the color inspection target printer set in a target range filter 5323, the UI control module 402 extracts only color inspection jobs corresponding to the designated printer and displays the color inspection result list 5324. Note that the target range filter 5323 is not limited to printers, and may be any information associated with a color inspection job.

In the first embodiment, in a case where a printer associated with a color inspection job is a printer having a plurality of printing mechanisms such as the connected printers 140, the UI control module 402 displays each printer color inspection result of the connected printers 140. In FIG. 5F, the color inspection results of the printers 140a and 140b are each displayed in the inspection result overview display area 5322. A color inspection result 5325 indicates a color inspection result for each printer, which is displayed for the number of printers that have undergone color inspection. In addition, the status of the quality pertaining to color inspection results of the respective printers 140a and 140b (pass/fail/measurement in progress/not yet measured, etc.) is displayed. Further, a quality level related to the color inspection result of the connected printers is displayed in accordance with each inspection result. In the example of FIG. 5F, in the color inspection corresponding to color inspection job specification 1 corresponding to ID “5501”, the results of the inspection for the charts printed by printer 1 and printer 2 of the connected printers 140 are both pass, and the quality level thereof is determined to be level A.

In the first embodiment, upon accepting the measurement results of the color inspection job from the measurement control module 404, the color inspection processing module 405 starts the color inspection processing. In the first embodiment, when both of the printers 140a and 140b have passed, the status of the connected printers is determined to be pass, but the present disclosure is not limited thereto, and the determination may be made from the average or difference of the respective outcomes.

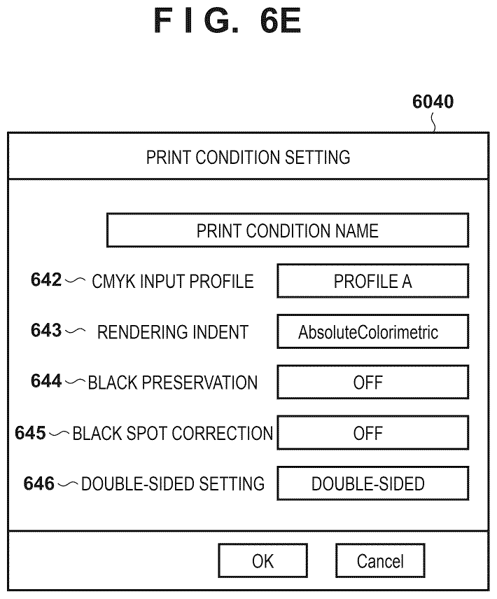

FIG. 7 is a sequence diagram for describing a flow of processing in the color inspection system according to the first embodiment. Hereinafter, an example in which the measurement for the color inspection of the printer 140a and the printer 140b of the connected printers 140 is performed collectively in a measurement job made to be a measurement target, and the color measurement results for the respective printers are transmitted as appropriate to perform the color inspection will be described. In the following description, the symbol “S” means a step for performing processing.

In step S701, the color inspection job specification setting module 401 of the color management apparatus 100 sets the color inspection job specifications based on user input accepted from the UI control module 402. As illustrated in FIG. 5A, it is assumed that the color inspection job specification 1 for the connected printers 140 (plain paper) which is the target of the color inspection are set.

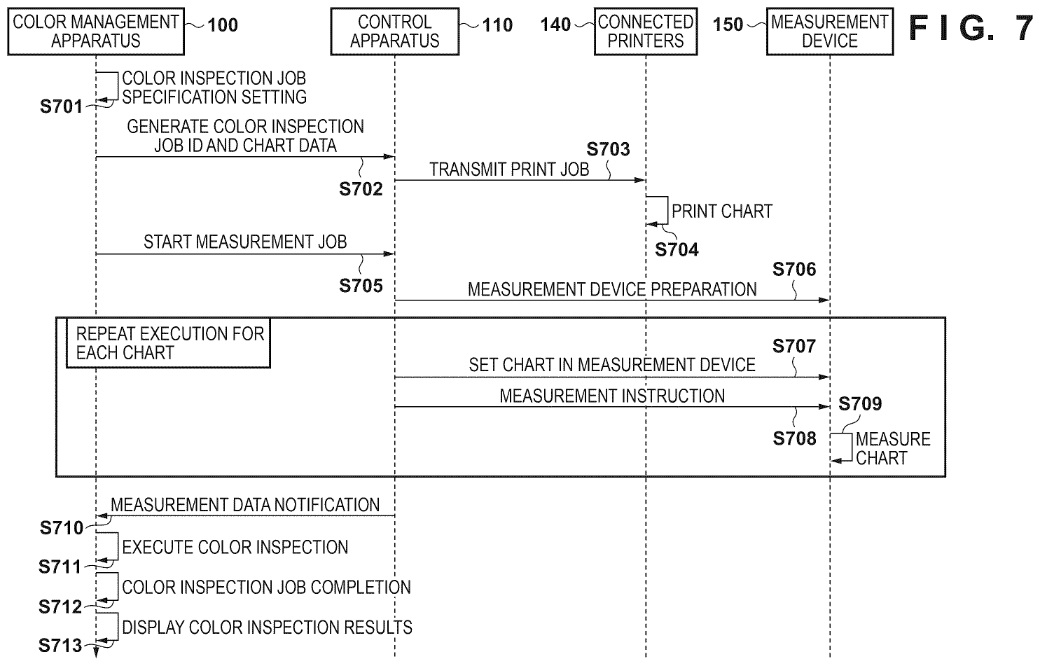

Next, the processing proceeds to step S702, and the color inspection job generation module 403 generates a color inspection job when a pressing of the “print chart” button 514 or the “download chart” button 515 is received in a state in which the color inspection job specification 1 has been designated from the UI control module 402, as illustrated in FIG. 5A. Then, the color inspection job generation module 403 issues a color inspection job ID “5501” for the color inspection job specification 1 (FIG. 5B). Then, the color inspection job generation module 403 generates a color inspection chart as illustrated in FIGS. 8A to 8C.

FIGS. 8A to 8C are diagrams illustrating an example of a color inspection chart according to a first embodiment. In this example, the printer 1 prints the chart on the front surface of a sheet, and the printer 2 prints the chart on the back surface of the sheet to perform double-sided printing.

Reference numeral 801 denotes a page number of the chart, and when the chart used for color inspection is composed of a plurality of pages, the number of the reference numeral 801 is incremented. Reference numeral 802 denotes a color inspection job ID (here, 5501). Reference numeral 803 denotes the printer for printing this chart, and is generated based on information obtained by the printer information obtaining module 406 and that indicates which surface the printers 1 (140a) and 2 (140b) are to print when the connected printers 140 perform double-sided printing. If the printer associated with the color inspection job specifications is not connected printers, the printer name may or may not be described. Reference numeral 804 denotes patches, which are composed of signal values based on chart specifications included in the color inspection job specification. In addition, patch sizes and a patch arrangement that can be measured by a designated measurement device are configured based on the information of the measurement device and the print layout information included in the color inspection job specification. FIG. 8A represents an image file including chart data that is generated by the color inspection job generation module 403 in a case where a printer associated with the color inspection job has a plurality of printing mechanisms, as in the case of the connected printers 140, and the double-sided setting is “double-sided”. Page 800 and pages 805 to 807 represent consecutive pages in the image file.

FIG. 8B represents a first page of a print material when double-sided printing is performed for the image file, and the reference numeral 808 represents the front surface of the first page and the reference numeral 809 represents the back surface of the first page. The page 800 in the image file is printed on the front surface of the first page of the chart as shown by the reference numeral 808, and the page 805 is printed on the back surface of the first page of the chart shown by the reference numeral 809.

FIG. 8C represents a second page of a print material when double-sided printing is performed for the image file of FIG. 8A, and the reference numeral 810 represents the front surface of the second page and the reference numeral 811 represents the back surface of the second page. The page 806 in the image file is printed on the front surface of the second page of the chart as shown by the reference numeral 810, and the page 807 is printed on the back surface of the second page of the chart as shown by the reference numeral 811. Here, the back surface indicated by the reference numeral 809 and the front surface indicated by the reference numeral 810 are blank sheets on which no chart is printed. As an example, in a case where a chart is to be generated as a PDF, a file in which the pages 800, 805, 806, and 807 are consecutive may be generated, as illustrated in FIG. 8A. When double-sided printing is performed in the connected printers 140 in this manner, the printer 140a generates a first page of the chart on which only the front surface indicated by the reference numeral 808 is printed, and the printer 140b generates a second page of the chart on which only the back surface indicated by the reference numeral 811 is printed.

In the first embodiment, by generating the image file in consideration of the above-described imposition, printing of the chart by all the printing mechanisms is realized on a printer having a plurality of printing mechanisms. However, the present disclosure is not limited to this. For example, in a case where the connected printers can accept printing imposition setting information (imposition information) separately from the image file, an image file including only pages in which chart data such as the page 800 and the page 807 is included is created. Then, printing may be performed by generating imposition setting information such that the print output is as in FIGS. 8B to 8C.

In a case where the “print chart” button 514 in FIG. 5A is pressed, the generated chart data and the information included in the color inspection job specification are transmitted to the control apparatus 110 via the network I/F 107. Also, in a case where the “download chart” button 515 is pressed, the generated chart data is transmitted from the color management apparatus 100 and can be downloaded via a color management application.

Then, in step S703, the control apparatus 110 generates a color inspection job (print job) based on information of the printer, the sheet, and the print conditions included in the received color inspection job specification, based on the received chart data, and transmits the generated print job to the target printer. In the first embodiment, the print job is transmitted to the connected printers 140.

In step S704, the connected printers 140, after having received the print job, perform print processing on the printer 140a and the printer 140b in accordance with the print job, and outputs a chart.

Then, in step S705, the measurement control module 404 starts the measurement job when a pressing of the color inspection job start button 5215 is received from the UI control module 402 in a state in which the color inspection job ID or the color inspection job specification are designated as illustrated in FIG. 5B.

In step S706, as illustrated in FIG. 5C, the control apparatus 110 searches for a measurement device connected to the control apparatus 110 based on the measurement device information included in the received color inspection job specification, and makes a connection request to the corresponding measurement device 150. Then, in cooperation with the measurement device 150, measurement device preparation such as calibration is performed.

Next, in step S707, the control apparatus 110 performs a process of prompting the user to measure the chart to which the measurement target ID has been added, as illustrated in FIG. 5D. Here, the user is prompted to be set the chart in the measurement device 150. Then, in step S708, the control apparatus 110 instructs the measurement device 150 to measure the chart. Thus, in step S709, the measurement device 150 measures the chart. Here, step S707 to step S709 are repeated for each of the printers 140a to 140b. Note that the chart measurement instruction to the measurement device 150 performed in step S708 to step S709, the measurement of the chart by the measurement device 150, and the notification of the measurement results to the control apparatus 110 are only one example. Depending on the type of the measurement device 150 and the measurement conditions, in addition to the method of instructing the measurement device and the measurement method, the units of notification of the measurement results such as units of patches, units of patch rows, and units of pages are also changed.

In step S710, as illustrated in FIG. 5E, the control apparatus 110 receives a pressing of the completion button 5242 from the UI control module 402 and notifies the color management apparatus 100 of the measurement results for each of the printers 140a and 140b of the connected printers 140. Then, in step S711 to step S712, the color management apparatus 100, after having received the measurement results, performs color inspection, and the color management apparatus 100 closes the color inspection job. In this way, measurement work of the plurality of printers can be performed collectively for the connected printers. Finally, in step S713, the color management apparatus 100 displays the color inspection results of the color inspection job as illustrated in FIG. 5F.

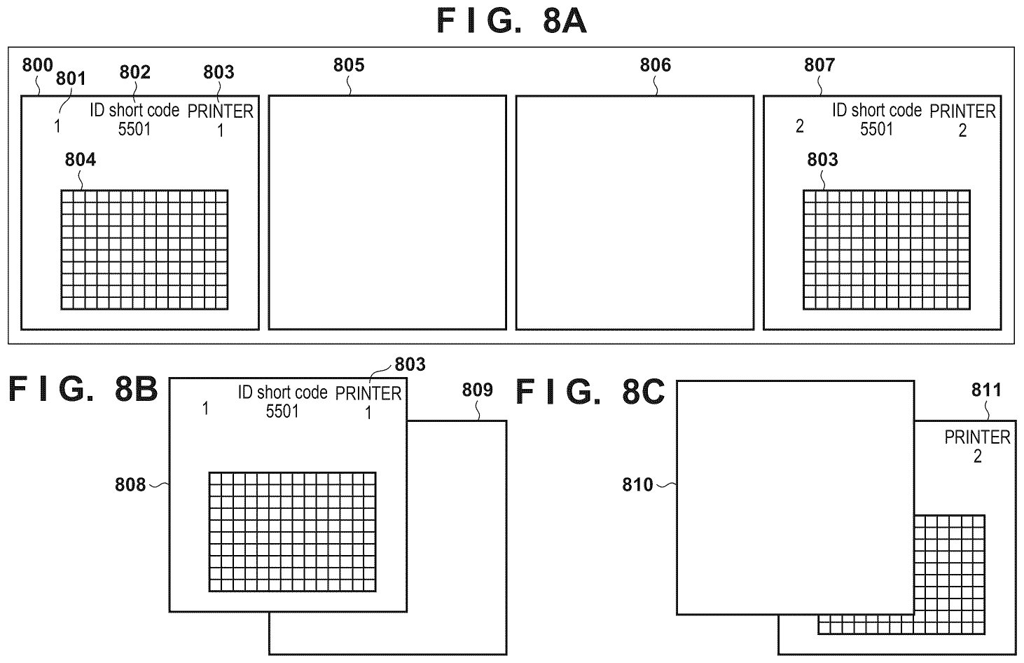

FIG. 9 is a flowchart for explaining processing when the color inspection job generation module 403 generates chart data in the color inspection system according to the first embodiment. Here, it is assumed that the CPU 101 of the control apparatus 110 deploys a program stored in the ROM 102 into the RAM 103 and executes the program, thereby achieving the processing described in this flowchart. Note that this processing is started when the UI control module 402 accepts the pressing of the “print chart” button 514 or the “download chart” button 515 illustrated in FIG. 5A.

First, in step S901, the CPU 101 determines whether or not the printer associated with the color inspection job specifications is connected printers 140. If it is determined that the printer associated with the color inspection job specifications is the connected printers 140, the processing proceeds to step S902, and if not, the processing proceeds to step S904. In step S904, the CPU 101 generates an image file including chart data for producing singled-sided print material that is similar to what is illustrated in FIG. 8B, for example, and ends the processing. Also, in a case of connected printers 140, in step S902, the CPU 101 determines whether or not the double-sided setting associated with the color inspection job specifications is “double-sided”. If not double-sided printing, the processing proceeds to step S905, and if double-sided printing, the processing proceeds to step S903. In step S903, the CPU 101 generates an image file including chart data for consecutive double-sided printing such that, for example, as illustrated in FIG. 8A, that the printer 140a prints the pages 800 and 805 and that the printer 140b prints the pages 806 and 807, and then the CPU 101 ends this processing. Also, when not double-sided, the CPU 101 in step S905 generates chart data such that the printer 140a and the printer 140b generate single-sided print material, and then the CPU 101 ends the processing.

The above is the flow of the entire process in the color inspection system according to the first embodiment. In the first embodiment, the measurement target is a color inspection job, but limitation is not made thereto, and a profile generation chart generated by a not-shown profile generation job generation module that corrects the colors of the printer may be used as the measurement target.

As described above, according to the first embodiment, color inspection by one color inspection job is made possible by generating chart data that is printed using double-sided printing by all printing mechanisms in a printer having a plurality of printing mechanisms, and thus efficient measurement work becomes possible.

### [Variation]

Next, as a variation of the first embodiment, an example will be described in which, when the color inspection job generation module 403 generates the chart data, rather than generating chart data as illustrated in the above-described FIGS. 8A to 8C, for example, imposition setting information such that print output becomes as in FIGS. 8B to 8C is used to generate the chart data.

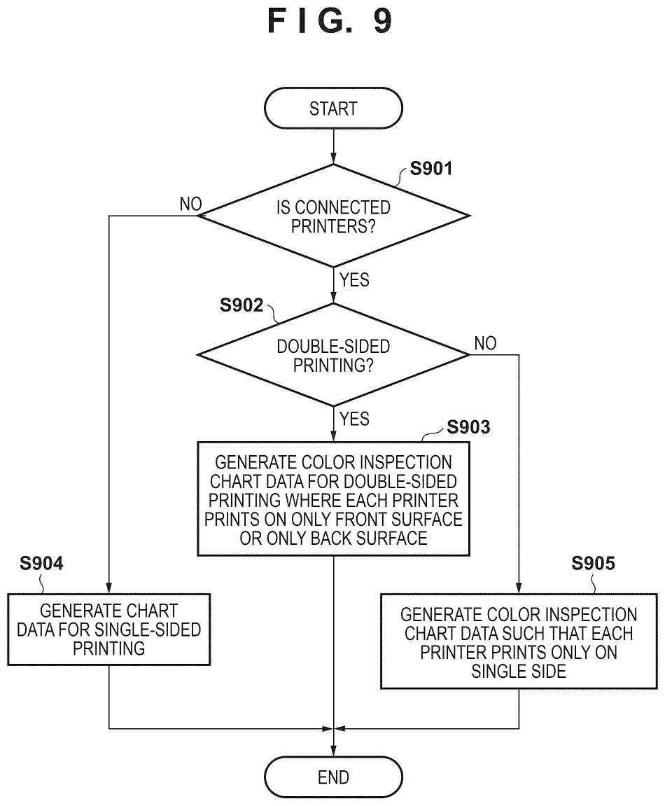

FIG. 10 is a flowchart for explaining processing when the color inspection job generation module 403 generates chart data in the color inspection system according to a variation example of the first embodiment. Here, it is assumed that the CPU 101 of the control apparatus 110 deploys a program stored in the ROM 102 into the RAM 103 and executes the program, thereby achieving the processing described in this flowchart. Note that this processing is started when the UI control module 402 accepts the pressing of the “print chart” button 514 or the “download chart” button 515 illustrated in FIG. 5A.

First, in step S1001, the CPU 101 determines whether or not the printer associated with the color inspection job specifications is connected printers 140. If it is determined that the printer associated with the color inspection job specifications is the connected printers 140, the processing proceeds to step S1002, and if not, the processing proceeds to step S1004. First, in step S1002, the CPU 101 determines whether or not the double-sided setting associated with the color inspection job specification is “double-sided”. If not double-sided printing, the processing proceeds to step S1004, and if double-sided printing, the processing proceeds to step S1003. In step S1004, the CPU 101 generates an image file including chart data for producing singled-sided print material that is similar to what is illustrated in FIG. 8B, for example, and ends the processing. The image file to be generated here is, for example, a page including chart data illustrated by a plurality of pages, pages in which the page number indicated by the reference number 801 are incremented continuing from page 800 are generated.

In step S1003, the CPU 101 determines whether connected printers that perform double-sided printing are capable of accepting imposition setting information for imposition of printing separately from the image file. If it is determined that imposition is possible, the processing proceeds to step S1006, and the CPU 101 generates the imposition setting information such that the print output is as in FIGS. 8B and 8C, together with chart data similar to that for producing singled-sided print material that is created in step S1004, and ends the processing. In addition, if it is determined that imposition is not possible in step S1003, the processing advances to step S1005, and as in step S903 of FIG. 9, the CPU 101 generates an image file including chart data for double-sided printing in which, as illustrated in FIG. 8A, the pages 800, 805, 806, and 807 are consecutive, and ends the processing.

In this embodiment as well, color inspection by one color inspection job is made possible by generating chart data that is printed using double-sided printing by all printing mechanisms in a printer having a plurality of printing mechanisms, thus enabling efficient measurement work.

### Second Embodiment

With the color inspection system described in the first embodiment, an example is given in which color inspection by one color inspection job is made possible by generating chart data that is printed using double-sided printing by all printing mechanisms in a printer having a plurality of printing mechanisms. However, cases in which a printer having a plurality of printing mechanisms performs color inspection after having narrowed down the printers used in the printing to a subset thereof, such as cases where a sheet is fed to the connected printers 140 for single-sided printing or cases where color inspection is to be performed again after color correction can be envisioned. Therefore, in the second embodiment, an example will be described in which, in a color inspection system including a plurality of printers such as connected printers, a chart is printed by only a subset of the printers to perform color inspection.

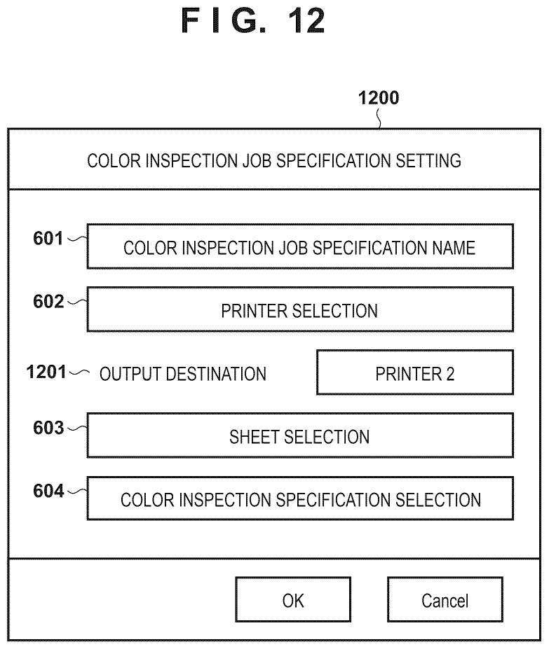

FIG. 12 depicts a view illustrating an example of a setting screen 1200 of a color inspection job specification according to the second embodiment. The setting screen 1200 is a color inspection job specification setting screen similar to that in FIG. 6A. In FIG. 12, the same components as those in FIG. 6A are denoted by the same reference numerals, and their explanations are omitted. An output destination 1201 can be selected when single-sided is set in the double-sided setting 646 in FIG. 6E, and a printer for printing a chart is designated among the printers 140a and 140b included in the connected printers 140.

In the measurement step of step 3 illustrated in FIG. 5D, in a case where single-sided is set in the double-sided setting of the color inspection job specification, the UI control module 402 displays only steps for measurement on the one printer in the display area 5211 out of all of the work steps in the measurement function. Here, for example, when the printer 2 (140b) is designated as illustrated in FIG. 12, only “step 3: printer 2” is displayed. Then, the printed chart printed using the designated printer 140b is measured.

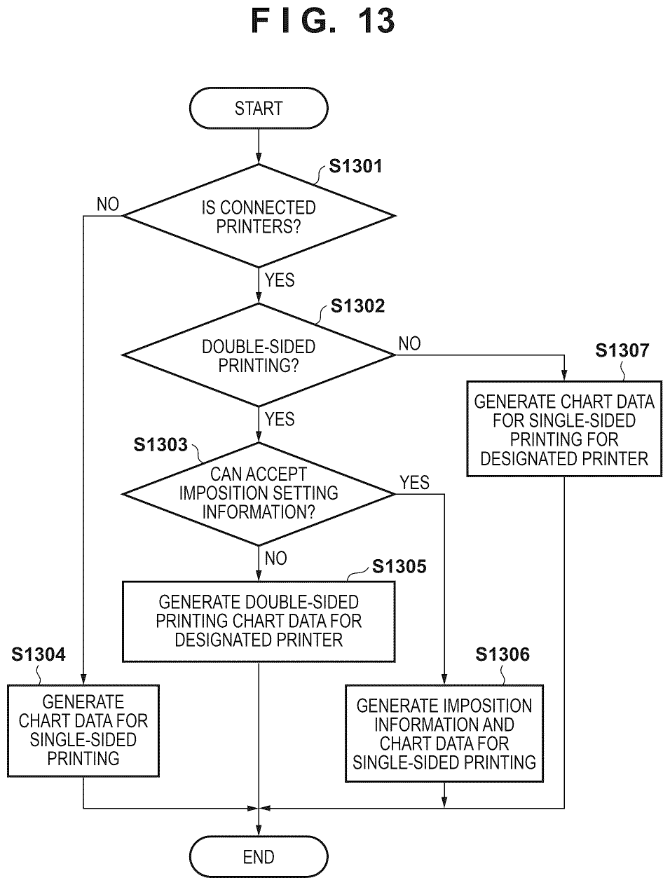

FIG. 13 is a flowchart for explaining processing when the color inspection job generation module 403 generates chart data in the color inspection system according to the second embodiment. Here, it is assumed that the CPU 101 of the control apparatus 110 deploys a program stored in the ROM 102 into the RAM 103 and executes the program, thereby achieving the processing described in this flowchart. Note that this processing is started when the UI control module 402 accepts the pressing of the “print chart” button 514 or the “download chart” button 515 illustrated in FIG. 5A. Here, a case where the color inspection job generation module 403 can generate the chart data using imposition setting information will be described, but in a case where imposition setting information is not used, for example, color inspection chart data deployed for each of the printers as illustrated in FIGS. 8A to 8C may be generated. Also, before this processing, it is assumed that the output destination printer is designated on the setting screen 1200 of FIG. 12.

First, in step S1301, the CPU 101 determines whether or not the printer associated with the color inspection job specification is connected printers 140. If it is determined that the printer associated with the color inspection job specifications is the connected printers 140, the processing proceeds to step S1302, and if not, the processing proceeds to step S1304. In step S1302, the CPU 101 determines whether or not the double-sided setting associated with the color inspection job specifications is “double-sided”. If not double-sided printing, the processing proceeds to step S1307, and if double-sided printing, the processing proceeds to step S1303. In step S1304, the CPU 101 generates an image file including chart data for producing singled-sided print material that is similar to what is illustrated in FIG. 8B, for example, in a printer designated as an output destination, and ends this processing. At this time, the printer that prints the chart indicated by the reference numeral 803 is the printer set in the output destination 1201 of FIG. 12. Also, the image file to be generated here is, for example, a page including chart data illustrated by page 800 in FIG. 8A. In a case where the chart used for color inspection is composed of a plurality of pages, pages whose page number as indicated by the reference number 801 increments continuing from page 800 are generated. In addition, in step S1307, the CPU 101 generates an image file including chart data for printing such that the print output on the designated printer is single-sided, and ends this processing.

In step S1303, the CPU 101 determines whether connected printers that perform double-sided printing are capable of accepting imposition setting information for printing imposition, separately from the image file. If it is determined that imposition is possible, the processing proceeds to step S1306, and the CPU 101 generates the imposition setting information such that the print output of the designated printer is as in FIGS. 8B and 8C, together with chart data similar to that for producing singled-sided print material that is created in step S1304, and ends the processing. In addition, if it is determined that imposition is impossible in step S1303, the processing proceeds to step S1305, and as illustrated in FIG. 8A, in the same manner as in the first embodiment, the CPU 101 generates an image file including chart data for printing such that the print output on the designated printers is on the front surface or the back surface, and ends this processing.

At this time, in the inspection result screen illustrated in FIG. 5F, the UI control module 402 assumes that the printer associated with the color inspection job is a printer having a plurality of printing mechanisms such as the connected printers 140, and that the double-sided setting 646 is single-sided printing. In this case, a color inspection result of one printer subjected to color inspection is displayed in the inspection result overview display area 5322. The color inspection result 5325 of the printer displays the color inspection result of the printer that is subjected to the color inspection, and displays the quality level related to the color inspection result of the connected printers in accordance with that result.

In addition, in a case where there is an execution history of color inspection jobs for which the same color inspection specifications were used, for example, in a case where color inspection is performed again after color correction, a color inspection result of a printer that is not re-subjected to color inspection out of the plurality connected printers may be referred to in the history and displayed in the inspection result overview display area 5322. At this time, the status of the quality related to the color inspection result of each of the printers 140a and 140b (such as pass/fail/measurement in progress/not yet measured) may be displayed, and also the quality levels related to the color inspection results of the connected printers may be displayed in accordance with each of the results.

In this way, according to the second embodiment, a chart is printed by only a subset of printing mechanisms of a printer having a plurality of printing mechanisms, and color inspection using single-sided printing is realized, whereby color inspection of connected printers can be performed more efficiently.

Further, in the above embodiment, an example in which the chart fits in one page is described, but for example, in a case where a chart spans a plurality of pages, in order to reduce the number of times the roll paper is cut, for example, the printer 140a may continuously print a plurality of pages on the front surface of the roll paper, and the printer 140b may consecutively print a plurality of pages on the back surface of the roll paper.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-147844, which was filed on Aug. 29, 2024 and which is hereby incorporated by reference herein in its entirety.

What is claimed is:

1. An information processing apparatus that, based on colorimetric data of patches arranged on charts printed by one or more printers, performs a color inspection of the printers, the information processing apparatus comprising:
one or more controllers including one or more processors and one or more memories, the one or more controllers configured to:
generate one color inspection job including chart data for performing color inspection of a plurality of printers; and
perform control to display a color inspection result based on the one color inspection job,
wherein, in the display of the color inspection result, the one or more controllers display a color inspection result for the one color inspection job and a color inspection result for each of the plurality of printers.

2. The information processing apparatus according to claim 1, wherein, in the generation of the one color inspection job, in a case where double-sided printing by the plurality of printers is possible, the one or more controllers generate the one color inspection job to include chart data of a front surface or a back surface to be printed by each of the plurality of printers.

3. The information processing apparatus according to claim 1, wherein, in the generation of the one color inspection job, in a case where double-sided printing by the plurality of printers is possible, the one or more controllers generate the one color inspection job to include chart data to be printed by the plurality of printers and imposition information designating a surface to be printed by each of the plurality of printers.

4. The information processing apparatus according to claim 3, wherein, in a case where double-sided printing by the plurality of printers is possible, the one or more controllers further obtain information indicating which surface each of the plurality of printers is to print, and
wherein in the generation of the one color inspection job, in a case where double-sided printing by the plurality of printers is possible, the one or more controllers generate the imposition information based on the obtained information.

5. The information processing apparatus according to claim 1, wherein the one or more controllers further
designate a printer for performing color inspection among the plurality of printers, and
generate a color inspection job including chart data for performing the color inspection of the designated printer.

6. The information processing apparatus according to claim 1, wherein in the display of the color inspection result, the one or more controllers obtain the color inspection result for each of the plurality of printers based on a difference between a reference color value of chart data based upon which the chart is printed and measurement data obtained by measuring the chart, and a threshold value for determining whether the color inspection passes or fails.

7. The information processing apparatus according to claim 6, wherein in the display of the color inspection result, the one or more controllers, in a case where at least one the color inspection result for each of the plurality of printers does not satisfy the threshold value, determine that the color inspection result for the one color inspection job for the plurality of printers is fail.

8. The information processing apparatus according to claim 1, wherein the color inspection job includes settings of a printer to be used in the color inspection job and a sheet to be printed by the printer.

9. A color inspection system comprising an information processing apparatus that, based on colorimetric data of patches arranged on charts printed by one or more printers, performs a color inspection of the printers, and a measurement device,
the information processing comprising:
one or more controllers including one or more processors and one or more memories, the one or more controllers configured to:
generate one color inspection job including chart data for performing color inspection of a plurality of printers; and
perform control to display a color inspection result based on the one color inspection job,
wherein, in the display of the color inspection result, the one or more controllers display a color inspection result for the one color inspection job and a color inspection result for each of the plurality of printers, and
wherein the measurement device generates the colorimetric data by measuring patches on the charts printed by the plurality of printers, respectively.

10. The color inspection system according to claim 9, wherein the chart data is generated based on a patch size and a patch arrangement that are measurable by the measurement device, based on information of the measurement device included in a specification of the color inspection.

11. The color inspection system according to claim 10, wherein a back surface of the surface on which the patches of the chart are arranged is blank.

12. A method of controlling an information processing apparatus that, based on colorimetric data of patches arranged on charts printed by one or more printers, performs a color inspection of the printers, the method comprising:
generating one color inspection job including chart data for performing color inspection of a plurality of printers; and
performing control to display a color inspection result based on the one color inspection job,
wherein, in the display of the color inspection result, a color inspection result for the one color inspection job and a color inspection result for each of the plurality of printers are displayed.

13. A non-transitory computer-readable storage medium storing a program for causing a processor to execute a method of controlling an information processing apparatus that, based on colorimetric data of patches arranged on charts printed by one or more printers, performs a color inspection of the printers, the method comprising:
generating one color inspection job including chart data for performing color inspection of a plurality of printers; and
performing control to display a color inspection result based on the one color inspection job,
wherein, in the display of the color inspection result, a color inspection result for the one color inspection job and a color inspection result for each of the plurality of printers are displayed.
